(19) United States
(12) Patent Application Publication
(10) Pub. No.: US 2012/0089457 A1
(43) Pub. Date: Apr. 12, 2012

(54) Search Container

(75) Inventors: Shashi SETH, Foster City, CA (US); Hari VASUDEV, Bangalore (IN); Gaurav MISHRA, Bangalore (IN)

(73) Assignee: YAHOO! INC., Sunnyvale, CA (US)

(21) Appl. No.: 12/900,735

(22) Filed: Oct. 8, 2010

(51) Int. Cl. G06Q 30/00; G06F 17/30

(52) U.S. Cl. 705/14.49; 707/769; 705/1.1; 707/E17.014

(57) ABSTRACT

Particular embodiments identify a search result in response to a search query issued by a user; select a web-based application based on the search query; construct a web page dynamically, the web page comprising: the search result; and a search container comprising an interface of the web-based application; and transmit the web page to a network device associated with the user for presentation to the user.

### TECHNICAL FIELD

The present disclosure generally relates to improving the quality of search results identified for search queries and more specifically relates to providing a search container in a web page containing a search result.

### BACKGROUND

The Internet provides a vast amount of information. The individual pieces of information are often referred to as “network resources” or “network contents” and may have various formats, such as, for example and without limitation, texts, audios, videos, images, web pages, documents, executables, etc. The network resources or contents are stored at many different sites, such as on computers and servers, in databases, etc., around the world. These different sites are communicatively linked to the Internet through various network infrastructures. Any person may access the publicly available network resources or contents via a suitable network device (e.g., a computer, a smart mobile telephone, etc.) connected to the Internet.

However, due to the sheer amount of information available on the Internet, it is impractical as well as impossible for a person (e.g., a network user) to manually search throughout the Internet for specific pieces of information. Instead, most network users rely on different types of computer-implemented tools to help them locate the desired network resources or contents. One of the most commonly and widely used computer-implemented tools is a search engine, such as the search engines provided by Microsoft® Inc. (http://www.bing.com), Yahoo!® Inc. (http://search.yahoo.com), and Google™ Inc. (http://www.google.com). To search for information relating to a specific subject matter or topic on the Internet, a network user typically provides a short phrase or a few keywords describing the subject matter, often referred to as a “search query” or simply “query”, to a search engine. The search engine conducts a search based on the search query using various search algorithms and generates a search result that identifies network resources or contents that are most likely to be related to the search query. The network resources or contents are presented to the network user, often in the form of a list of links, each link being associated with a different network document (e.g., a web page) that contains some of the identified network resources or contents. In particular embodiments, each link is in the form of a Uniform Resource Locator (URL) that specifies where the corresponding document is located and the mechanism for retrieving it. The network user is then able to click on the URL links to view the specific network resources or contents contained in the corresponding document as he wishes.

Sophisticated search engines implement many other functionalities in addition to merely identifying the network resources or contents as a part of the search process. For example, a search engine usually ranks the identified network resources or contents according to their relative degrees of relevance with respect to the search query, such that the network resources or contents that are relatively more relevant to the search query are ranked higher and consequently are presented to the network user before the network resources or contents that are relatively less relevant to the search query. The search engine may also provide a short summary of each of the identified network resources or contents.

There are continuous efforts to improve the qualities of the search results generated by the search engines. Accuracy, completeness, presentation order, speed, user friendliness are but a few of the performance aspects of the search engines for improvement.

### SUMMARY

The present disclosure generally relates to improving the quality of search results identified for search queries and more specifically relates to providing a search container in a web page containing a search result.

Particular embodiments identify a search result in response to a search query issued by a user; select a web-based application based on the search query; construct a web page dynamically, the web page comprising: the search result; and a search container comprising an interface of the web-based application; and transmit the web page to a network device associated with the user for presentation to the user.

These and other features, aspects, and advantages of the disclosure are described in more detail below in the detailed description and in conjunction with the following figures.

### BRIEF DESCRIPTION OF THE DRAWINGS

FIG. 1 (prior art) illustrates an example web page that contains a search result.

FIG. 2 illustrates an example method for including a search container in a web page.

FIGS. 3-13 illustrates examples of the search container.

FIG. 14 illustrates an example network environment.

FIG. 15 illustrates an example computer system.

### DESCRIPTION OF EXAMPLE EMBODIMENTS

The present disclosure is now described in detail with reference to a few embodiments thereof as illustrated in the accompanying drawings. In the following description, numerous specific details are set forth in order to provide a thorough understanding of the present disclosure. However, the present disclosure may be practiced without some or all of these specific details. In other instances, well known process steps and/or structures have not been described in detail in order not to unnecessarily obscure the present disclosure. In addition, while the disclosure is described in conjunction with the particular embodiments, it should be understood that this description is not intended to limit the disclosure to the described embodiments. To the contrary, the description is intended to cover alternatives, modifications, and equivalents as may be included within the spirit and scope of the disclosure as defined by the appended claims.

A search engine is a computer-implemented tool designed to search for information relevant to specific subject matters or topics on a network, such as the Internet, the World Wide Web, or an Intranet. To conduct a search, a network user may issue a search query to the search engine. The search query generally contains one or more words that describe a subject matter. In response, the search engine may identify one or more network resources that are likely to be related to the search query, which may collectively be referred to as a “search result” identified for the search query. Sophisticated search engines implement many other functionalities in addition to merely identifying the network resources as a part of the search process. For example, a search engine usually ranks the network resources identified for a search query according to their relative degrees of relevance with respect to the search query, such that the network resources that are relatively more relevant to the search query are ranked higher and consequently are presented to the network user before the network resources that are relatively less relevant to the search query. The search engine may also provide a short summary of each of the identified network resources.

To present the search result to the network user, typically, a web page is dynamically constructed, which contains the individual network resources identified for the search query.

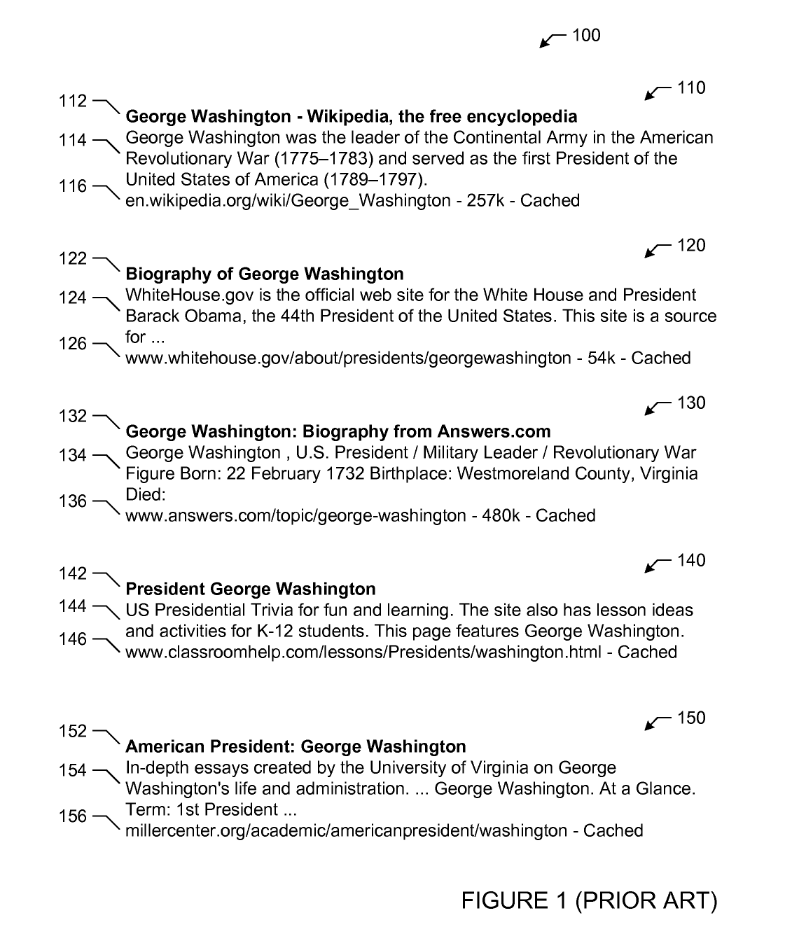

FIG. 1 illustrates an example web page 100 that contains a search result, which identifies five network resources and more specifically, five web pages 110, 120, 130, 140, 150. The search result is generated in response to an example search query “George Washington”. Note that only five network resources are illustrated in order to simplify the discussion. In practice, a search result may identify hundreds, thousands, or even millions of network resources. Network resources 110, 120, 130, 140, 150 each includes a title 112, 122, 132, 142, 152, a short summary 114, 124, 134, 144, 154 that briefly describes the respective network resource, and a clickable link 116, 126, 136, 146, 156 in the form of a URL. For example, network resource 110 is a web page provided by WIKIPEDIA that contains information concerning George Washington. The URL of this particular web page is “en.wikipedia.org/wiki/George_Washington”. To view the actual content contained in the WIKIPEDIA web page, the network user may click on the URL, which causes the web page to be displayed in a web browser.

Network resources 110, 120, 130, 140, 150 are presented according to their relative degrees of relevance to search query “President George Washington”. That is, network resource 110 is considered somewhat more relevant to search query “President George Washington” than network resource 120, which is in turn considered somewhat more relevant than network resource 130, and so on. Consequently, network resource 110 is presented first (i.e., at the top of web page 100) followed by network resource 120, network resource 130, and so on. To view any of network resource 110, 120, 130, 140, 150, the network user requesting the search may click on the individual URLs of the specific web pages.

As a business model, a search engine provider (e.g., Yahoo® Inc.) may sell advertising spaces to third-party advertisers on its web pages in order to generate revenue. For example, if a network user issues a search query “notebook computer” to the search engine, the dynamic web page constructed for the network user may contain the individual network resources identified for query “notebook computer” as well as a number of advertising links to third-party websites that sell notebook computers. The third-party websites may pay the search engine provider based on some predefined contractual agreement (e.g., based on the amount of revenue the third-party websites are able to generate as a result of placing their advertisements in the web pages of the search engine provider). If the user is interested in any of the third-party websites, the user may click on the corresponding URL to be directed to the third-party website.

The third-party advertisements placed in the existing web pages that contain search results usually are textual advertisements. Furthermore, if a user wishes to utilize the services provided at a third-party website, he needs to click on the link associated with the third-party advertisement to be directed to the third-party website, which means the user needs to leave the web page that contains the search result and the third-party advertisements.

Particular embodiments enhance the search experience for network users by providing a search container within a web page containing the search result identified in response to a search query. The search container may contain an application interface of a third-party application and/or additional advertisements specifically related to the search query. The application interface enables a network user to interact with the third-party application without having to leave the web page that contains the search result and the search container. In particular embodiments, the search container may provide additional advertising space that may be utilized to generate revenue for the search engine provider.

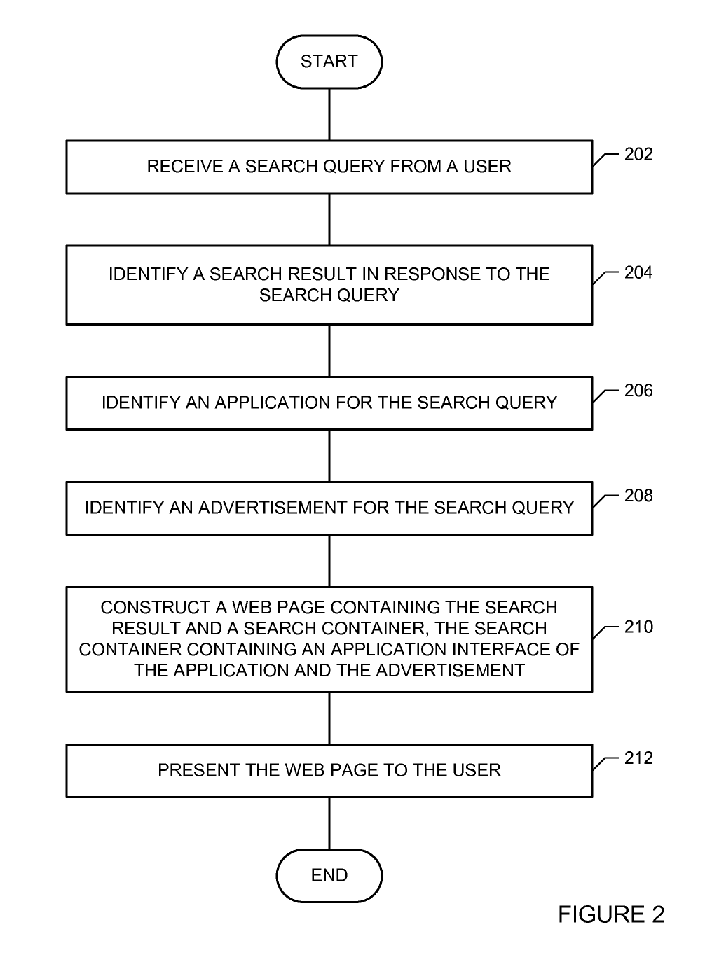

FIG. 2 illustrates an example method for including a search container in a web page. In particular embodiments, a search engine may receive a search query from a user (step 202 of FIG. 2). In particular embodiments, the search engine may be hosted on one or more servers or other types of computing devices. To issue a search query to the search engine, the user may access a web page provided by the search engine via a web browser running on a network device and enter the search query in an input field contained in the web page. The web browser may establish a HTTP (i.e., Hypertext Transfer Protocol) connection with the web engine host and transmit the search query to the web engine. In particular embodiments, the search engine may identify a number of network resources in response to the search query using various appropriate searching and ranking algorithms (step 204 of FIG. 2). The network resources may form a search result in response to the search query.

In particular embodiments, there may exist any number of web-based applications. In particular embodiments, the search engine is aware of these web-based applications or has access to these web-based applications. In particular embodiments, some of these web-based applications may be provided by any number of third parties who have established relationships (e.g., contractual relationships or partner relationships) with the provider of the search engine. In particular embodiments, some of these web-based applications may be provided by the search engine provider itself. In particular embodiments, these web-based applications may have been registered with the search engine, and the search engine may access these web-based applications as needed. In particular embodiments, each web-based application may be a user-interactive application and has a user interface through which a user may interact with the application. In particular embodiments, the user interface of the application may be multimedia based and may include text, audio, or video components. In particular embodiments, the user interface of the application may be included in a web page as a component of the web page.

In particular embodiments, the third-party application placed in a search container may be a web-based social networking application. A user may log into the social networking application directly through the user interface of the application provided in the search container (i.e., without having to leave the web page), and interacts with his friends and connections on the social network or any other suitable activities.

In particular embodiments, the search engine or a component functioning in association with the search engine may identify one of the web-based applications for the search query (step 206 of FIG. 2). There are various ways to match a web-based application to a search query. In particular embodiments, each web-based application may be associated with a set of keywords. If the search query contains some or all of the keywords associated with a web-based application, that web-based application may be matched up with the search query. If the search query contains the keywords associated with multiple web-based applications, in particular embodiments, the web-based application that has the most number of keywords contained in the search query may be selected. Alternatively, in particular embodiments, each third party may be invited to bid on the search query (e.g., similar to an auction), and the web-based application of the third party submitting the highest bid may be selected. In particular embodiments, the selection of the web-based application for a particular search query may be based on previously defined contractual agreement betweens the search engine provider and the individual third parties.

In particular embodiments, there may exist any number of advertisements. In particular embodiments, these advertisements may be provided by advertisers who may or may not be the same entities as the third parties that provided the web-based applications. In particular embodiments, the search engine is aware of these advertisements or of the advertisers that wish to advertise with the search engine provider.

Optionally, in particular embodiments, the search engine or a component functioning in association with the search engine may identify one or more advertisements for the search query (step 208 of FIG. 2). Again, there are various ways to match an advertisement to a search query. In particular embodiments, each advertiser is invited to bid on the search query, and the advertisements of the advertisers submitting the highest bids may be selected.

In particular embodiments, a web page may be dynamically constructed as a response to the search query (step 210 of FIG. 2). The web page may contain the search result (i.e., the network resources) identified for the search query and a search container. In particular embodiments, the search container may contain an application interface for the web-based application identified for the search query. Optionally, the search container may also contain one or more advertisements identified for the search query. The web page may be presented to the user who has issued the search query (step 212 of FIG. 2). For example, the web page may be transmitted to the user's network device (e.g., via a HTTP connection) and displayed in the web browser running on the user's network device. Thereafter, the user may interact with the web-based application through the interface presented in the search container. For example, if the user provides an input to the web-based application via its interface presented in the search container, the web-based application may display a response in its interface, again presented in the search container. In this manner, the user may use the web-based application without having to leave the web page that contains the search result and the search container. The user may also click on the advertisement presented in the search container.

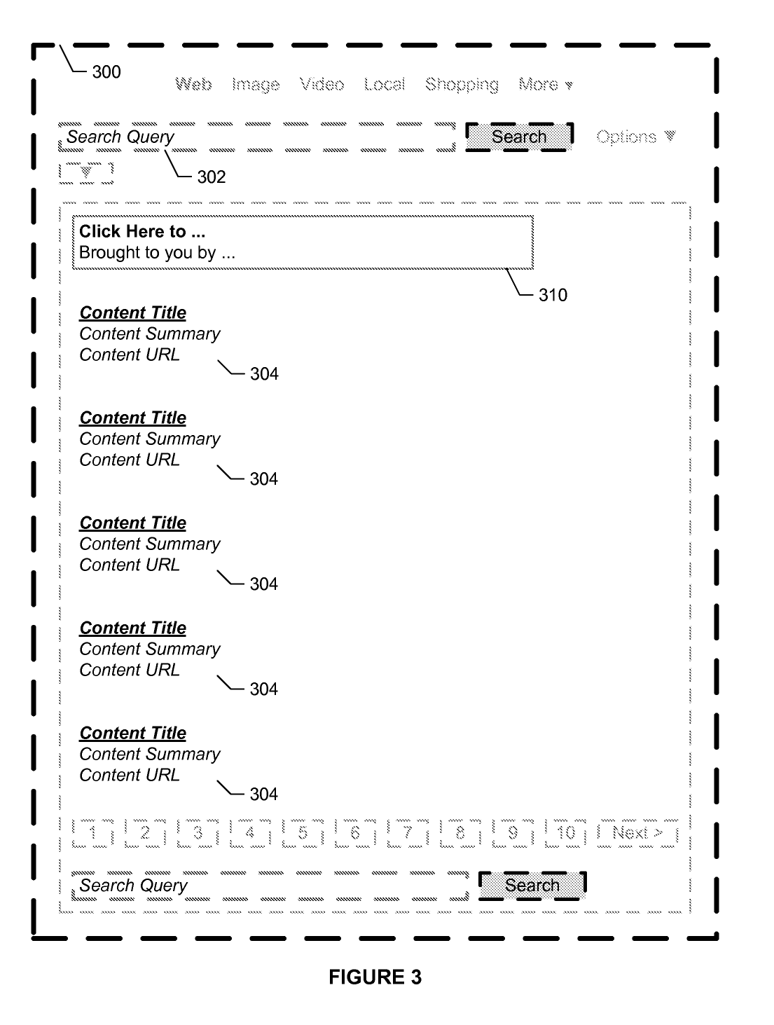

To further describe the search container, FIGS. 3-13 illustrates various examples of the search container. FIG. 3 illustrates an example web page 300 dynamically constructed in response to a search query 302. Web page 300 includes several network resources 304 identified for search query 302 by a search engine. In addition, web page 300 includes a search container 310. In this example, search container 310 initially includes a message and a link to the web-based application identified for search query 302. The message asks the user to click on the link so that the interface of the web-based application may be displayed inside search container 310. By giving the user a choice, search container 310 is not intrusive as the user may choose not to see the complete content of search container 310 by not clicking on the provided link.

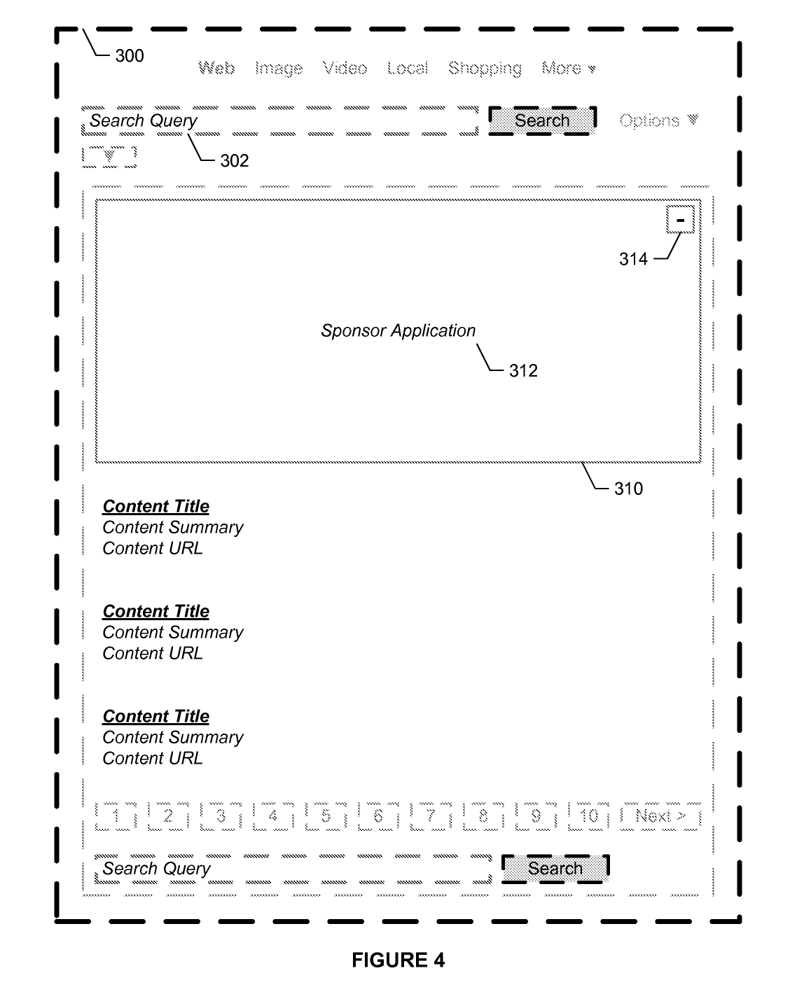

Suppose the user clicks on the link provided in search container 310. Search container 310 may expand to show the interface of the web-based application identified for search query 302. FIG. 4 illustrates web page 300, including the expanded search container 310. An interface 312 of the web-based application may be included and displayed inside search container 310. The user may interact with the web-based application via interface 312.

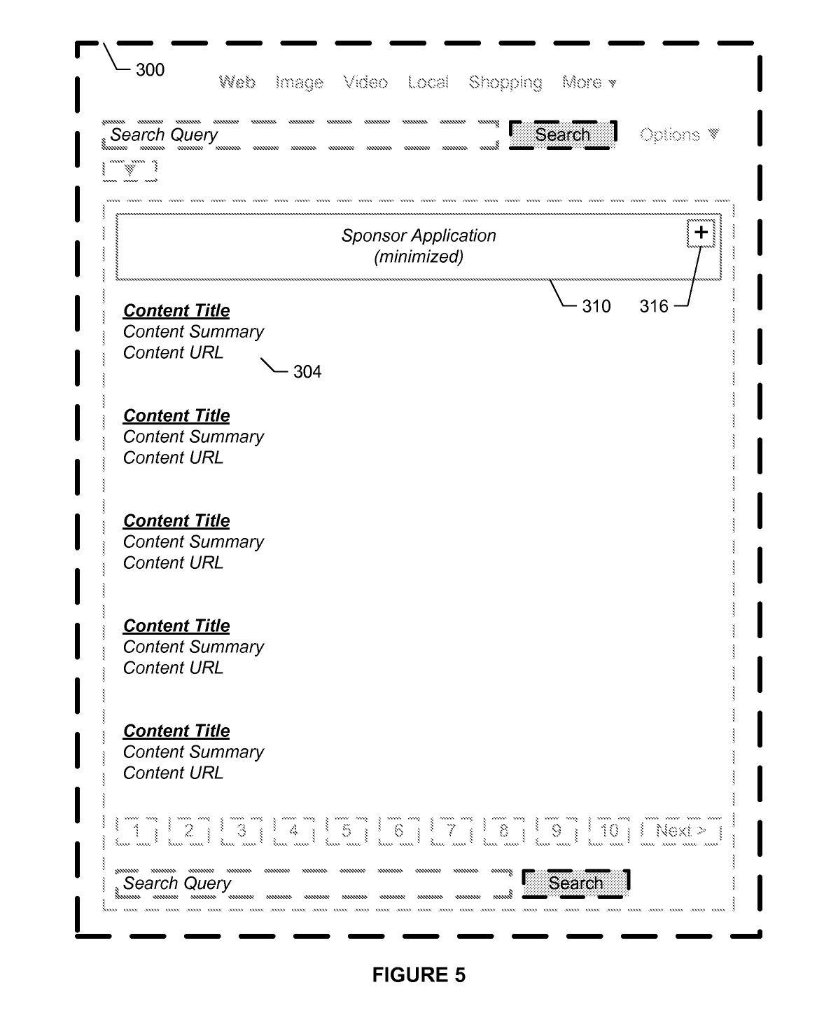

When search container is expanded to show interface 312 of the web-based application, some of the network resources 304 may be covered up. Thus, in particular embodiments, an icon 314 may be provided in association with the expanded search container 310 so that the user may click on it to minimize search container 310. FIG. 5 illustrates web page 300, but with search container 310 minimized. Once search container 310 is minimized, the network resources that have been covered up (e.g., network resource 304) may be visible again. Another icon 316 may be provided in associated with the minimized search container 310 so that the user may click on it to expand search container 310 as needed.

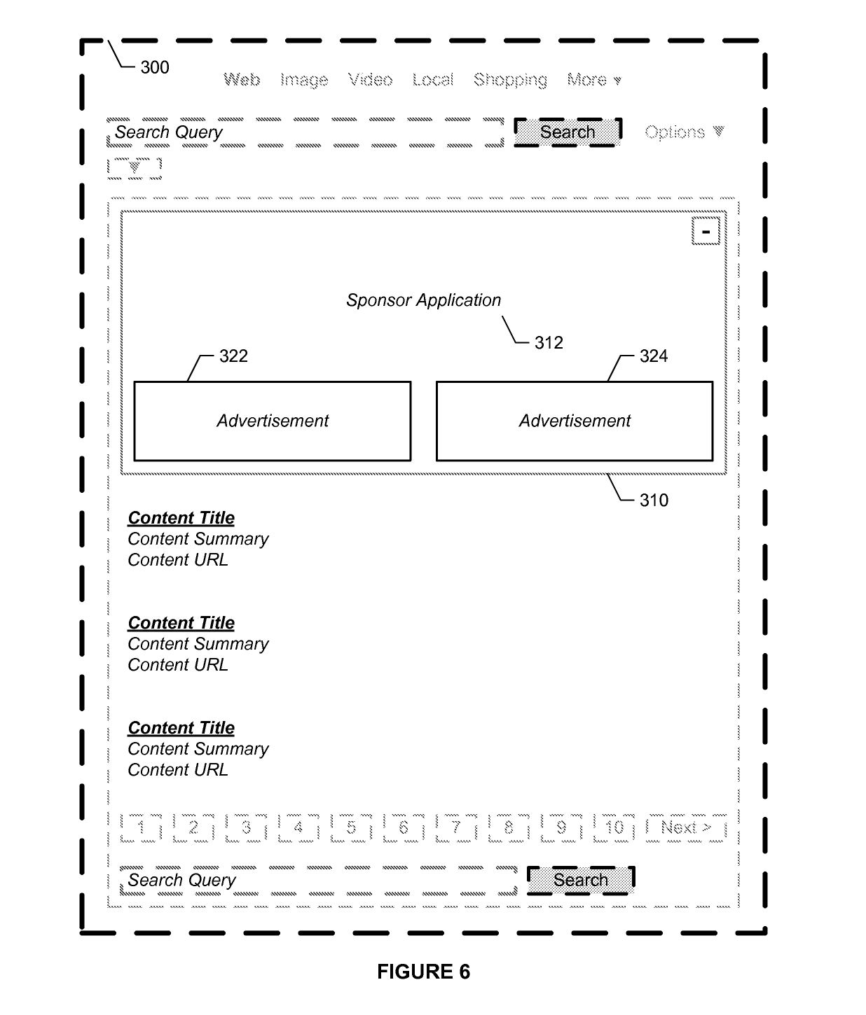

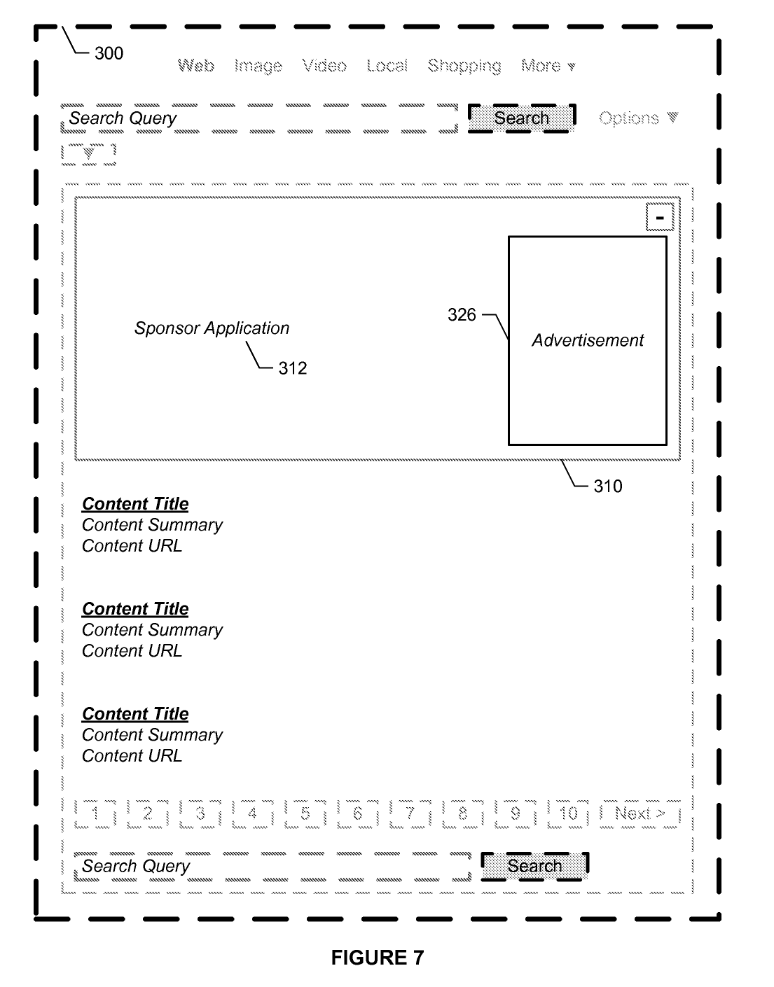

In particular embodiments, a search container may contain any number of advertisements in addition to the interface of the web-based application. FIG. 6 illustrates web page 300, where search container 310 includes interface 312 of the web-based application as well as two advertisements 322 and 324 placed below interface 312. Of course, the advertisements may be placed inside a search container at any suitable locations. FIG. 7 illustrates web page 300, where search container 310 includes interface 312 of the web-based application and an advertisement 326 placed to the right of interface 312.

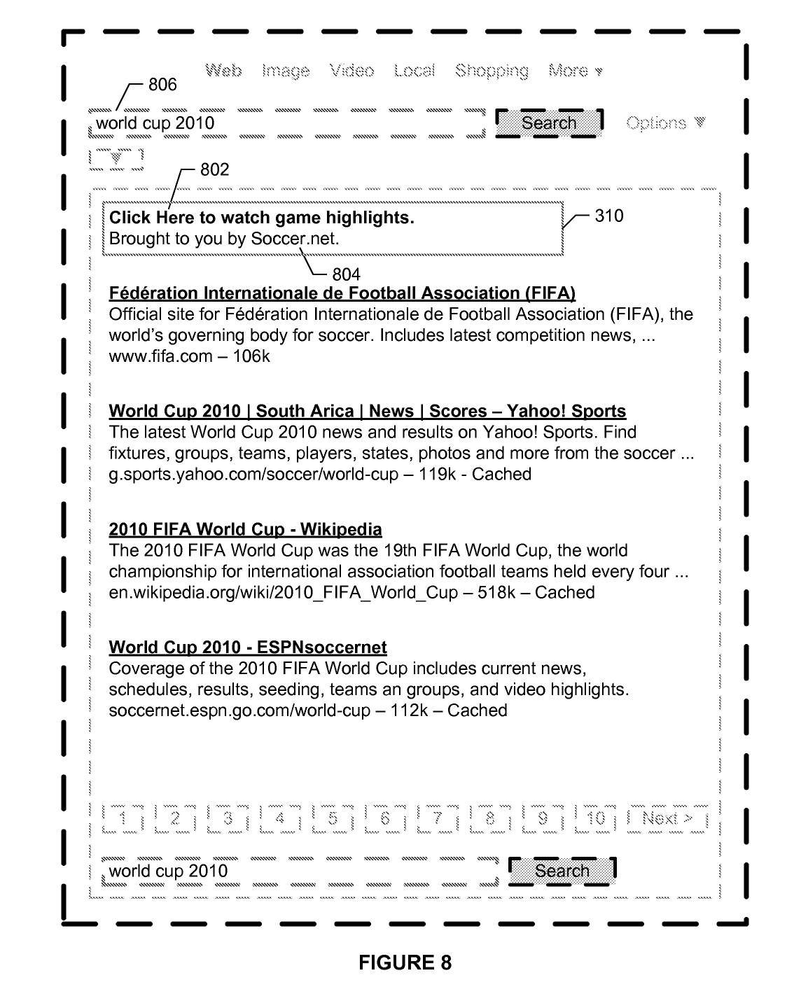

In particular embodiments, the web-based application selected to be included in the search container relates to the search query issued by the user. For example, in FIG. 8, suppose a user has provided a search query 806, “world cup 2010”. The web-based application selected based on search query 806 may be related to the World Cup of 2010, such as a multimedia application that enables a user to watch videos of the games from the World Cup 2010. Thus, in FIG. 8, search container 310 may initially contain a message to the user, directing the user to click on a link 802 provided inside search container 310 if the user wishes to watch a video of the game highlights. In addition, the third party 804 that is associated with the application (i.e., the third party providing the application) may be identified as a part of the message, thus providing public exposure to the third party (e.g., Soccer.net).

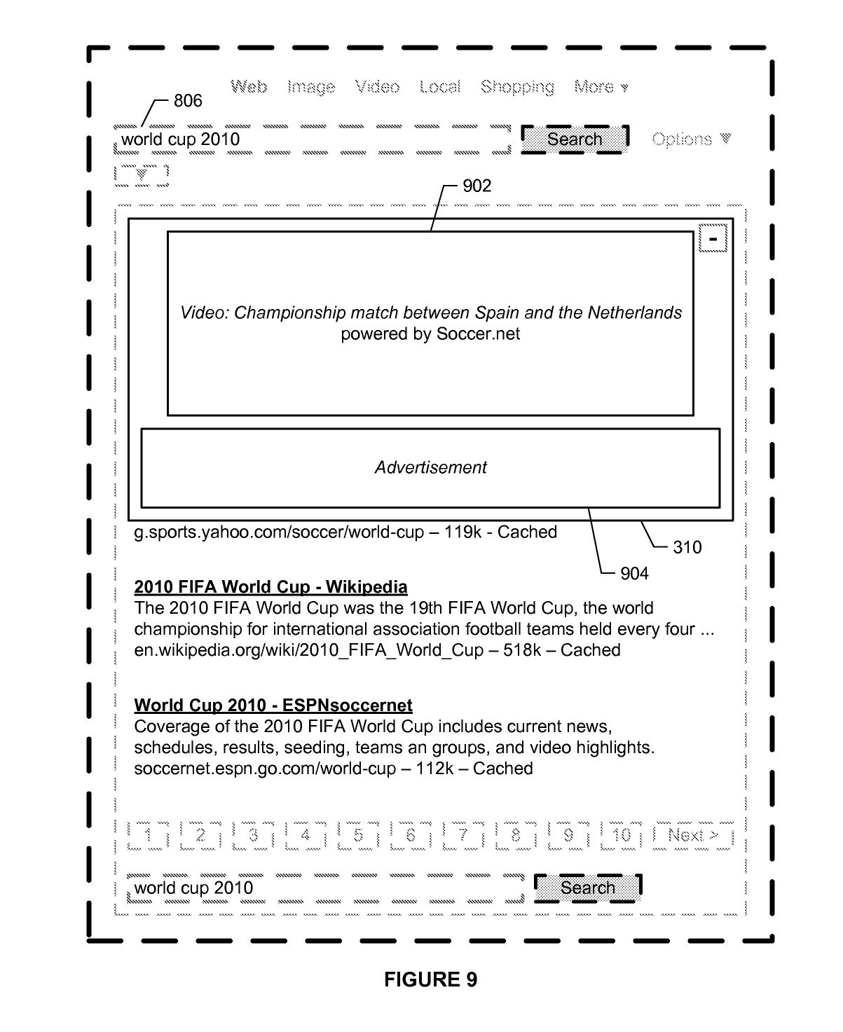

Suppose the user wishes to watch the game highlights and thus clicks on link 802. In particular embodiments, this input from the user may cause search container 310 to expand, as illustrated in FIG. 9. A multimedia user interface 902 may be displayed inside the expanded search container 310. User interface 902 may include a video component (e.g., a flash component) that plays a video of the game highlights from World Cup 2010. A user may view a video directly via user interface 902 presented in search container 310 without having to leave the web page that contains search container 310. In addition, search container 310 may also include an advertisement 904, which may also be selected based on search query 806, such as an advertisement about sports shoes or soccer apparel.

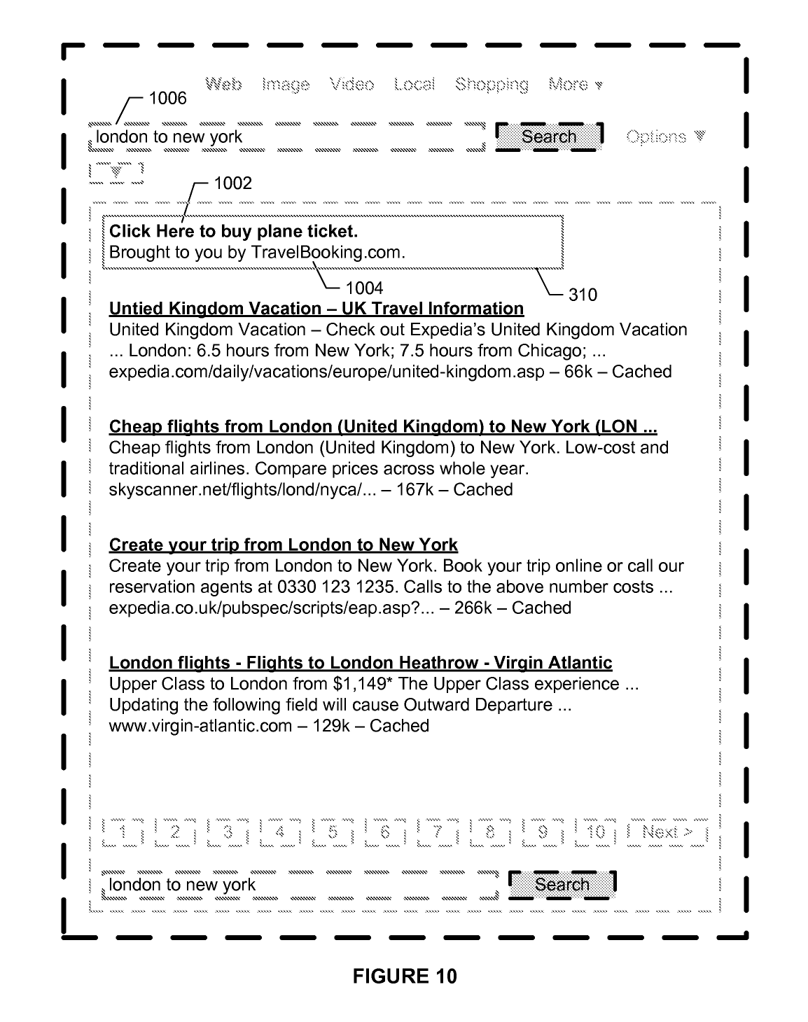

As another example, in FIG. 10, suppose a user has provided a search query 1006, “London to New York”. It may be inferred from search query 1006 that the user may be interested in travelling from London to New York. Thus, the third-party application selected based on search query 1006 may be an online travel service application. In FIG. 10, search container 310 may initially contain a message to the user, asking the user to click on a link 1002 if he wishes to buy plane tickets (e.g., plane ticket form London to New York). The third party 1004 that provides the travel service application is TravelBooking.com, which is also identified in search container 310.

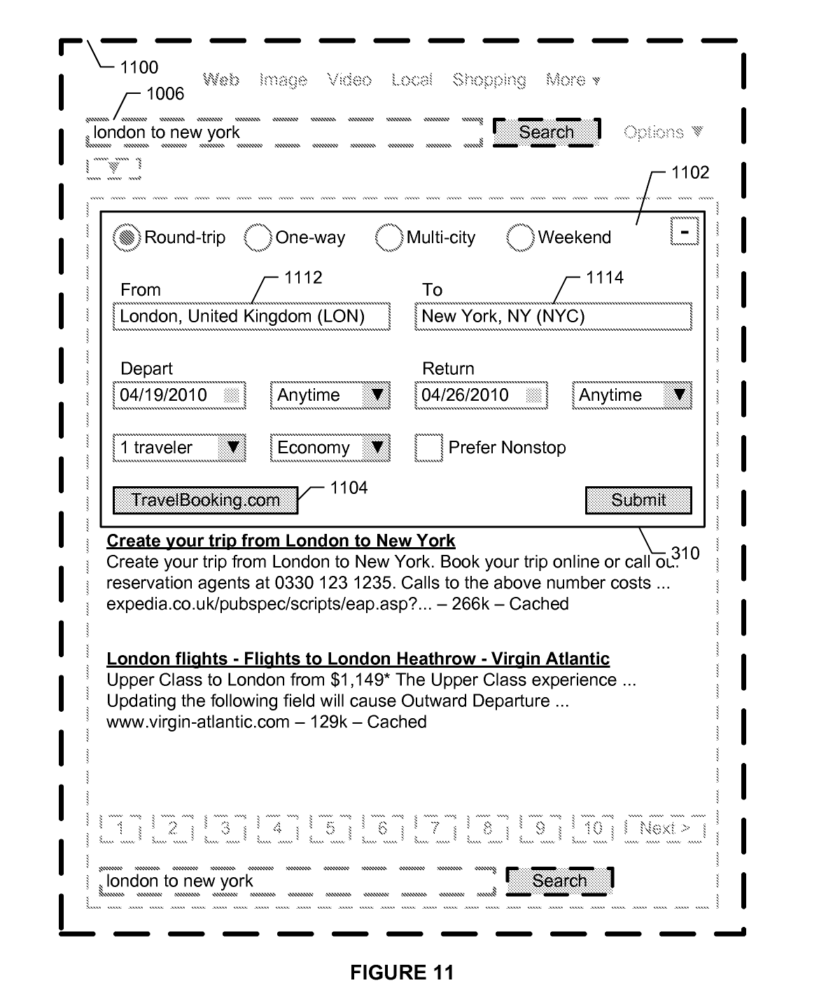

Suppose the user clicks on link 1002. This action results in a user input that causes search container 310 to expand. In FIG. 11, the expanded search 310 contains the interface f of the travel service application provided by TravelBooking.com. Search container 310 may also contain the logo 1104 of TravelBooking.com. The user may purchase plane tickets from TravelBooking.com directly through interface 1102 provided inside search container 310, without having to leave web page 1100, which contains the search result identified for search query 1006 (i.e., without having to actually visit the website of TravelBooking.com).

To make the search container more user friendly, in particular embodiments, the search query issued by the user or the information derived from the search query may be provided to the third-party application identified based on the search query. For example, search query 1006 suggests that the user is interested in traveling from London to New York. This information may be provided to the travel service application associated with TravelBooking.com. When search container 310 is expanded to display interface 1102, the origin 1112 and destination 1114 fields have already been filled out as London and New York, respectively, so that the user does not have to enter the information explicitly.

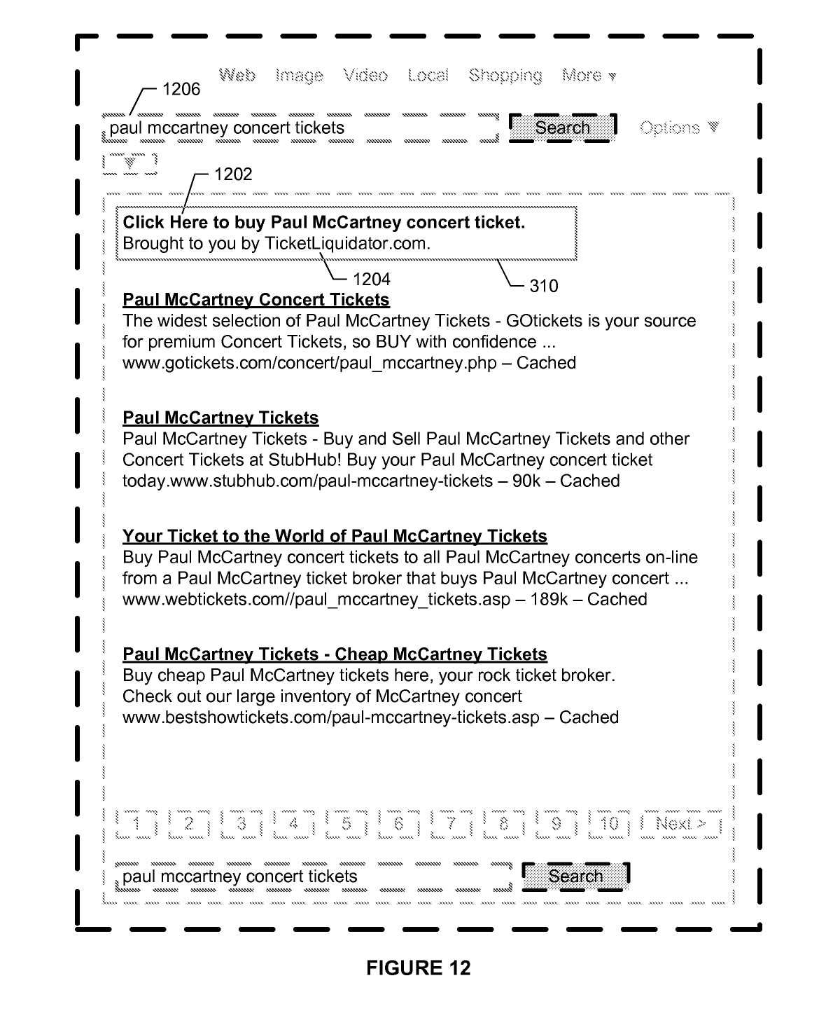

As a third example, in FIG. 12, suppose a user has provided a search query 1206, “Paul McCartney concert tickets”. It may be inferred from search query 1206 that the user may be interested in purchasing Paul McCartney's concert ticket. Thus, the third-party application selected based on search query 1206 may be an application that sells various types of tickets. In FIG. 12, search container 310 may initially contain a message to the user, asking the user to click on a link 1202 if he wishes to buy Paul McCartney concert tickets. The third party 1204 that provides the application is TicketLiquidator.com, which is also identified in search container 310.

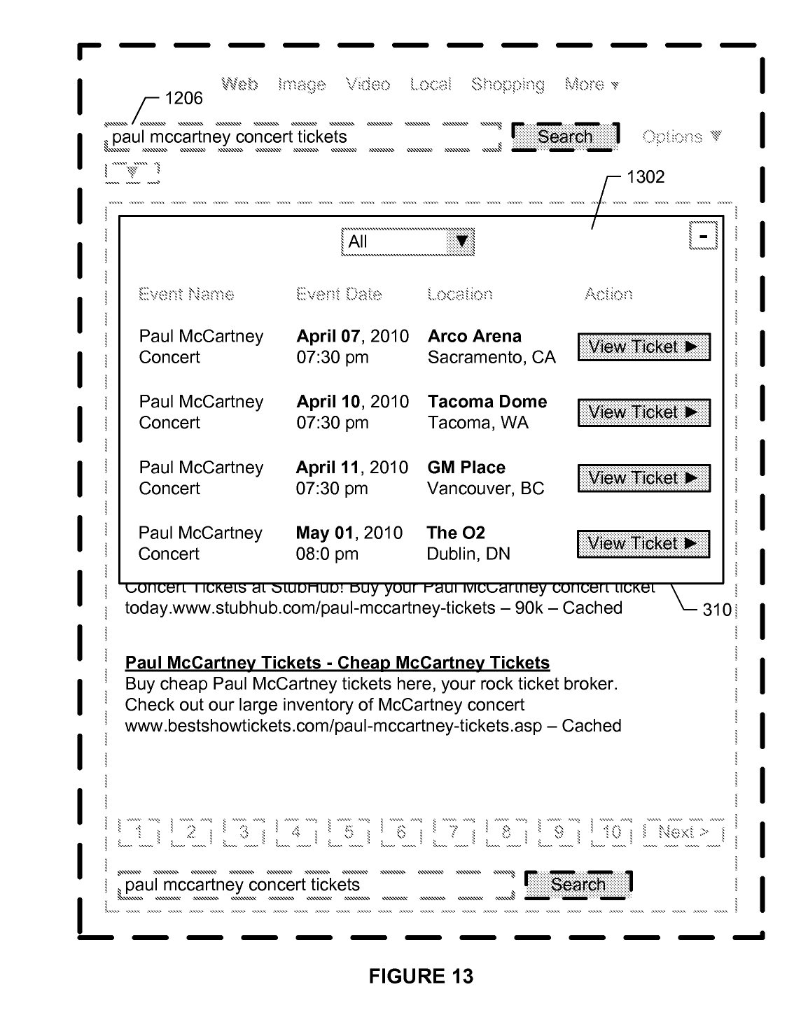

Suppose the user clicks on link 1202. This action results in a user input that causes search container 310 to expand. In FIG. 13, the expanded search 310 contains the interface 1302 of the application that sells concert tickets, which is provided by TicketLiquidator.com. The user may purchase Paul McCartney's concert tickets from TicketLiquidator.com directly through interface 1302 provided inside search container 310, without having to leave the web page that contains search container 310 and actually visit the website of TicketLiquidator.com.

Again, since from search query 1206, it may be inferred that the user is interested in Paul McCartney's concert tickets, this information may be provided to the third-party application so that, initially, only Paul McCartney concerts are displayed in interface 1302. If the user is interested in tickets of other events, he may select additional events using suitable components provided in interface 1302.

Currently, search engine providers generate revenue mostly through selling advertising spaces on their web pages. However, the amount of space on the web pages that may be used for advertising purposes is limited. Search containers provide additional means for search engine providers to generate revenue. For example, a search engine provider may receive payments from third parties for including their applications inside search containers. If a third-party is able to complete a sale through the search container, the search engine provider may share a part of the profit resulted from that sale. A search engine provider may also receive payments from advertisers for including their advertisements inside search containers. The payments may be computed based on some pre-determined contractual agreements, such as based on the number of clicks the advertisements received or the number of conversions resulted from users clicking on the advertisements or any applicable method.

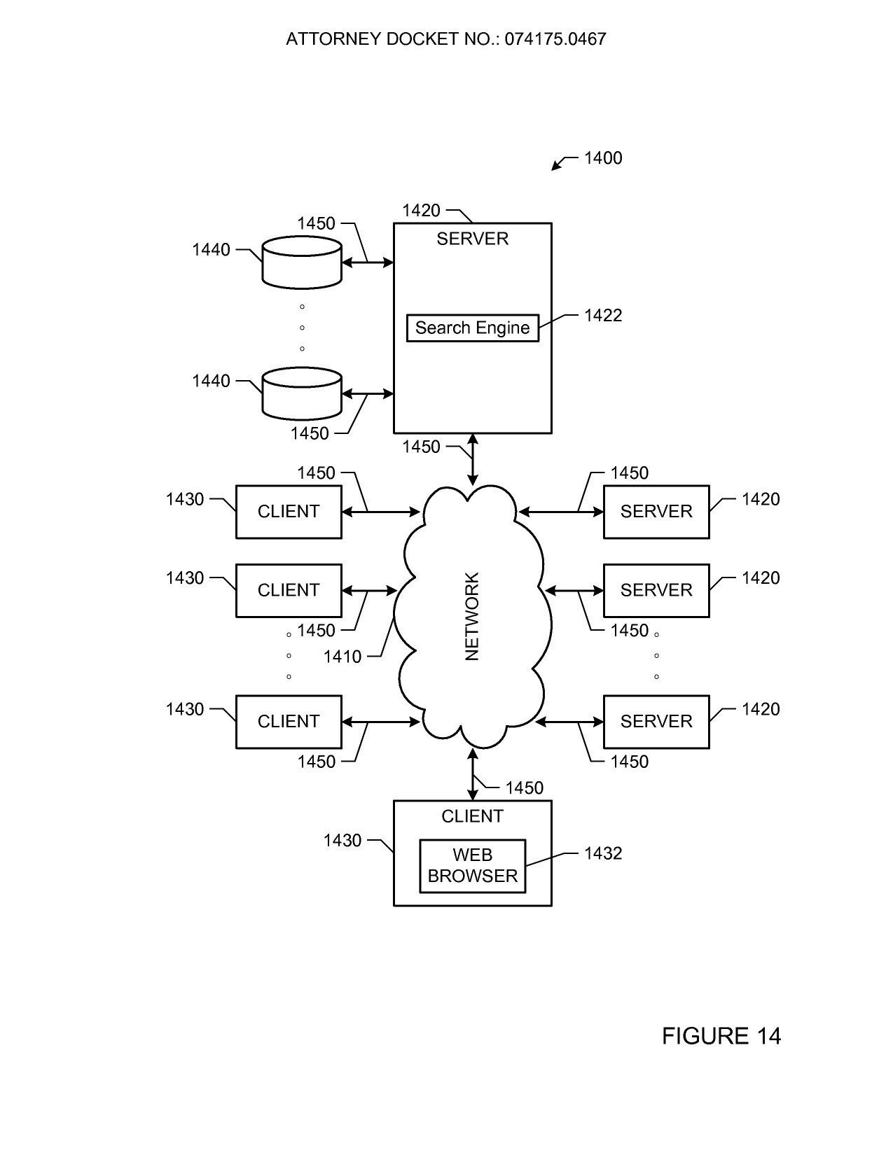

Particular embodiments may be implemented in a network environment. FIG. 14 illustrates an example network environment 1400 suitable for providing software validation as a service. Network environment 1400 includes a network 1410 coupling one or more servers 1420 and one or more clients 1430 to each other. In particular embodiments, network 1410 is an intranet, an extranet, a virtual private network (VPN), a local area network (LAN), a wireless LAN (WLAN), a wide area network (WAN), a metropolitan area network (MAN), a portion of the Internet, or another network 1410 or a combination of two or more such networks 1410. The present disclosure contemplates any suitable network 1410.

One or more links 1450 couple a server 1420 or a client 1430 to network 1410. In particular embodiments, one or more links 1450 each includes one or more wireline, wireless, or optical links 1450. In particular embodiments, one or more links 1450 each includes an intranet, an extranet, a VPN, a LAN, a WLAN, a WAN, a MAN, a portion of the Internet, or another link 1450 or a combination of two or more such links 1450. The present disclosure contemplates any suitable links 1450 coupling servers 1420 and clients 1430 to network 1410.

In particular embodiments, each server 1420 may be a unitary server or may be a distributed server spanning multiple computers or multiple datacenters. Servers 1420 may be of various types, such as, for example and without limitation, web server, news server, mail server, message server, advertising server, file server, application server, exchange server, database server, or proxy server. In particular embodiments, each server 1420 may include hardware, software, or embedded logic components or a combination of two or more such components for carrying out the appropriate functionalities implemented or supported by server 1420. For example, a web server is generally capable of hosting websites containing web pages or particular elements of web pages. More specifically, a web server may host HTML files or other file types, or may dynamically create or constitute files upon a request, and communicate them to clients 1430 in response to HTTP or other requests from clients 1430. A mail server is generally capable of providing electronic mail services to various clients 1430. A database server is generally capable of providing an interface for managing data stored in one or more data stores.

In particular embodiments, a search engine 1422 may be hosted on a server 1420. Search engine 1422 may include hardware, software, or embedded logic components or a combination of two or more such components and capable of carrying out the appropriate functionalities implemented or supported by search engine 1422. For example, search engine 1422 may perform the steps illustrated in FIG. 2.

In particular embodiments, one or more data storages 1440 may be communicatively linked to one or more severs 1420 via one or more links 1450. In particular embodiments, data storages 1440 may be used to store various types of information. In particular embodiments, the information stored in data storages 1440 may be organized according to specific data structures. In particular embodiment, each data storage 1440 may be a relational database. Particular embodiments may provide interfaces that enable servers 1420 or clients 1430 to manage, e.g., retrieve, modify, add, or delete, the information stored in data storage 1440.

In particular embodiments, each client 1430 may be an electronic device including hardware, software, or embedded logic components or a combination of two or more such components and capable of carrying out the appropriate functionalities implemented or supported by client 1430. For example and without limitation, a client 1430 may be a desktop computer system, a notebook computer system, a netbook computer system, a handheld electronic device, or a mobile telephone. The present disclosure contemplates any suitable clients 1430. A client 1430 may enable a network user at client 1430 to access network 1430. A client 1430 may enable its user to communicate with other users at other clients 1430.

A client 1430 may have a web browser 1432, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client 1430 may enter a Uniform Resource Locator (URL) or other address directing the web browser 1432 to a server 1420, and the web browser 1432 may generate a Hyper Text Transfer Protocol (HTTP) request and communicate the HTTP request to server 1420. Server 1420 may accept the HTTP request and communicate to client 1430 one or more Hyper Text Markup Language (HTML) files responsive to the HTTP request. Client 1430 may render a web page based on the HTML files from server 1420 for presentation to the user. The present disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web page encompasses one or more corresponding web page files (which a browser may use to render the web page) and vice versa, where appropriate.

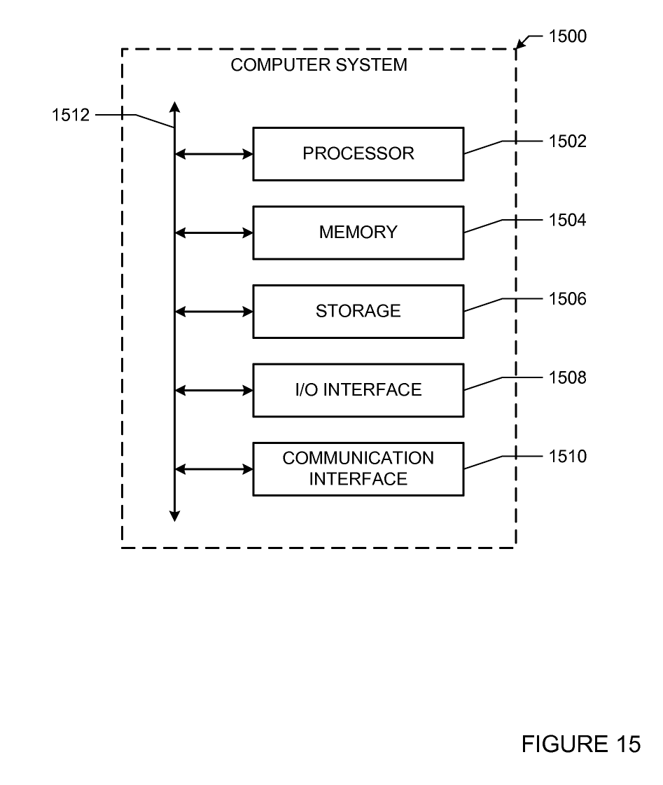

Particular embodiments may be implemented on one or more computer systems. FIG. 15 illustrates an example computer system 1500. In particular embodiments, one or more computer systems 1500 perform one or more steps of one or more methods described or illustrated herein. In particular embodiments, one or more computer systems 1500 provide functionality described or illustrated herein. In particular embodiments, software running on one or more computer systems 1500 performs one or more steps of one or more methods described or illustrated herein or provides functionality described or illustrated herein. Particular embodiments include one or more portions of one or more computer systems 1500.

This disclosure contemplates any suitable number of computer systems 1500. This disclosure contemplates computer system 1500 taking any suitable physical form. As example and not by way of limitation, computer system 1500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer system 1500 may include one or more computer systems 1500; be unitary or distributed; span multiple locations; span multiple machines; or reside in a cloud, which may include one or more cloud components in one or more networks. Where appropriate, one or more computer systems 1500 may perform without substantial spatial or temporal limitation one or more steps of one or more methods described or illustrated herein. As an example and not by way of limitation, one or more computer systems 1500 may perform in real time or in batch mode one or more steps of one or more methods described or illustrated herein. One or more computer systems 1500 may perform at different times or at different locations one or more steps of one or more methods described or illustrated herein, where appropriate.

In particular embodiments, computer system 1500 includes a processor 1502, memory 1504, storage 1506, an input/output (I/O) interface 1508, a communication interface 1510, and a bus 1512. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1502 includes hardware for executing instructions, such as those making up a computer program. As an example and not by way of limitation, to execute instructions, processor 1502 may retrieve (or fetch) the instructions from an internal register, an internal cache, memory 1504, or storage 1506; decode and execute them; and then write one or more results to an internal register, an internal cache, memory 1504, or storage 1506. In particular embodiments, processor 1502 may include one or more internal caches for data, instructions, or addresses. The present disclosure contemplates processor 1502 including any suitable number of any suitable internal caches, where appropriate. As an example and not by way of limitation, processor 1502 may include one or more instruction caches, one or more data caches, and one or more translation lookaside buffers (TLBs). Instructions in the instruction caches may be copies of instructions in memory 1504 or storage 1506, and the instruction caches may speed up retrieval of those instructions by processor 1502. Data in the data caches may be copies of data in memory 1504 or storage 1506 for instructions executing at processor 1502 to operate on; the results of previous instructions executed at processor 1502 for access by subsequent instructions executing at processor 1502 or for writing to memory 1504 or storage 1506; or other suitable data. The data caches may speed up read or write operations by processor 1502. The TLBs may speed up virtual-address translation for processor 1502. In particular embodiments, processor 1502 may include one or more internal registers for data, instructions, or addresses. The present disclosure contemplates processor 1502 including any suitable number of any suitable internal registers, where appropriate. Where appropriate, processor 1502 may include one or more arithmetic logic units (ALUs); be a multi-core processor; or include one or more processors 1502. Although this disclosure describes and illustrates a particular processor, this disclosure contemplates any suitable processor.

In particular embodiments, memory 1504 includes main memory for storing instructions for processor 1502 to execute or data for processor 1502 to operate on. As an example and not by way of limitation, computer system 1500 may load instructions from storage 1506 or another source (such as, for example, another computer system 1500) to memory 1504. Processor 1502 may then load the instructions from memory 1504 to an internal register or internal cache. To execute the instructions, processor 1502 may retrieve the instructions from the internal register or internal cache and decode them. During or after execution of the instructions, processor 1502 may write one or more results (which may be intermediate or final results) to the internal register or internal cache. Processor 1502 may then write one or more of those results to memory 1504. In particular embodiments, processor 1502 executes only instructions in one or more internal registers or internal caches or in memory 1504 (as opposed to storage 1506 or elsewhere) and operates only on data in one or more internal registers or internal caches or in memory 1504 (as opposed to storage 1506 or elsewhere). One or more memory buses (which may each include an address bus and a data bus) may couple processor 1502 to memory 1504. Bus 1512 may include one or more memory buses, as described below. In particular embodiments, one or more memory management units (MMUs) reside between processor 1502 and memory 1504 and facilitate accesses to memory 1504 requested by processor 1502. In particular embodiments, memory 1504 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. The present disclosure contemplates any suitable RAM. Memory 1504 may include one or more memories 1504, where appropriate. Although this disclosure describes and illustrates particular memory, this disclosure contemplates any suitable memory.

In particular embodiments, storage 1506 includes mass storage for data or instructions. As an example and not by way of limitation, storage 1506 may include an HDD, a floppy disk drive, flash memory, an optical disc, a magneto-optical disc, magnetic tape, or a Universal Serial Bus (USB) drive or a combination of two or more of these. Storage 1506 may include removable or non-removable (or fixed) media, where appropriate. Storage 1506 may be internal or external to computer system 1500, where appropriate. In particular embodiments, storage 1506 is non-volatile, solid-state memory. In particular embodiments, storage 1506 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1506 taking any suitable physical form. Storage 1506 may include one or more storage control units facilitating communication between processor 1502 and storage 1506, where appropriate. Where appropriate, storage 1506 may include one or more storages 1506. Although this disclosure describes and illustrates particular storage, this disclosure contemplates any suitable storage.

In particular embodiments, I/O interface 1508 includes hardware, software, or both providing one or more interfaces for communication between computer system 1500 and one or more I/O devices. Computer system 1500 may include one or more of these I/O devices, where appropriate. One or more of these I/O devices may enable communication between a person and computer system 1500. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1508 for them. Where appropriate, I/O interface 1508 may include one or more device or software drivers enabling processor 1502 to drive one or more of these I/O devices. I/O interface 1508 may include one or more I/O interfaces 1508, where appropriate. Although this disclosure describes and illustrates a particular I/O interface, this disclosure contemplates any suitable I/O interface.

In particular embodiments, communication interface 1510 includes hardware, software, or both providing one or more interfaces for communication (such as, for example, packet-based communication) between computer system 1500 and one or more other computer systems 1500 or one or more networks. As an example and not by way of limitation, communication interface 1510 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1510 for it. As an example and not by way of limitation, computer system 1500 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1500 may include any suitable communication interface 1510 for any of these networks, where appropriate. Communication interface 1510 may include one or more communication interfaces 1510, where appropriate. Although this disclosure describes and illustrates a particular communication interface, this disclosure contemplates any suitable communication interface.

In particular embodiments, bus 1512 includes hardware, software, or both coupling components of computer system 1500 to each other. As an example and not by way of limitation, bus 1512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these. Bus 1512 may include one or more buses 1512, where appropriate. Although this disclosure describes and illustrates a particular bus, this disclosure contemplates any suitable bus or interconnect.

Herein, reference to a computer-readable storage medium encompasses one or more non-transitory, tangible computer-readable storage media possessing structure. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. Herein, reference to a computer-readable storage medium excludes any medium that is not eligible for patent protection under 35 U.S.C. §101. Herein, reference to a computer-readable storage medium excludes transitory forms of signal transmission (such as a propagating electrical or electromagnetic signal per se) to the extent that they are not eligible for patent protection under 35 U.S.C. §101. A computer-readable non-transitory storage medium may be volatile, non-volatile, or a combination of volatile and non-volatile, where appropriate.

This disclosure contemplates one or more computer-readable storage media implementing any suitable storage. In particular embodiments, a computer-readable storage medium implements one or more portions of processor 1502 (such as, for example, one or more internal registers or caches), one or more portions of memory 1504, one or more portions of storage 1506, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody software. Herein, reference to software may encompass one or more applications, bytecode, one or more computer programs, one or more executables, one or more instructions, logic, machine code, one or more scripts, or source code, and vice versa, where appropriate. In particular embodiments, software includes one or more application programming interfaces (APIs). This disclosure contemplates any suitable software written or otherwise expressed in any suitable programming language or combination of programming languages. In particular embodiments, software is expressed as source code or object code. In particular embodiments, software is expressed in a higher-level programming language, such as, for example, C, Perl, or a suitable extension thereof. In particular embodiments, software is expressed in a lower-level programming language, such as assembly language (or machine code). In particular embodiments, software is expressed in JAVA. In particular embodiments, software is expressed in Hyper Text Markup Language (HTML), Extensible Markup Language (XML), or other suitable markup language.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

What is claimed is:

1. A method, comprising: by one or more computing devices,
identifying a search result in response to a search query issued by a user;
selecting a web-based application based on the search query;
constructing a web page dynamically, the web page comprising:
the search result; and
a search container comprising an interface of the web-based application; and
transmitting the web page to a network device associated with the user for presentation to the user.

2. The method of claim 1, further comprising receiving revenue from a third-party associated with the web-based application.

3. The method of claim 1, further comprising selecting an advertisement based on the search query, wherein the search container further comprises the advertisement.

4. The method of claim 3, further comprising receiving revenue from a third-party associated with the advertisement.

5. The method of claim 1, further comprising:
receiving an input to the web-based application from the user via the interface of the web-based application presented to the user in the search container;
updating the interface of the web-based application in response to the input; and
transmitting the updated interface of the web-based application to the network device associated with the user for presentation to the user in the search container.

6. A system, comprising:
a memory comprising instructions executable by one or more processors; and
the one or more processors coupled to the memory and operable to execute the instructions, the one or more processors being operable when executing the instructions to:
identify a search result in response to a search query issued by a user;
select a web-based application based on the search query;
construct a web page dynamically, the web page comprising:
the search result; and
a search container comprising an interface of the web-based application; and
transmit the web page to a network device associated with the user for presentation to the user.

7. The system of claim 6, wherein the one or more processors are further operable when executing the instructions to receive revenue from a third-party associated with the web-based application.

8. The system of claim 6, wherein the one or more processors are further operable when executing the instructions to select an advertisement based on the search query, wherein the search container further comprises the advertisement.

9. The system of claim 8, wherein the one or more processors are further operable when executing the instructions to receive revenue from a third-party associated with the advertisement.

10. The system of claim 6, wherein the one or more processors are further operable when executing the instructions to:
receive an input to the web-based application from the user via the interface of the web-based application presented to the user in the search container;
update the interface of the web-based application in response to the input; and
transmit the updated interface of the web-based application to the network device associated with the user for presentation to the user in the search container.

11. One or more computer-readable tangible storage media embodying software operable when executed by one or more computer systems to:
identify a search result in response to a search query issued by a user;
select a web-based application based on the search query;
construct a web page dynamically, the web page comprising:
the search result; and
a search container comprising an interface of the web-based application; and
transmit the web page to a network device associated with the user for presentation to the user.

12. The media of claim 11, wherein the software is further operable when executed by one or more computer systems to receive revenue from a third-party associated with the web-based application.

13. The media of claim 11, wherein the software is further operable when executed by one or more computer systems to select an advertisement based on the search query, wherein the search container further comprises the advertisement.

14. The media of claim 13, wherein the software is further operable when executed by one or more computer systems to receive revenue from a third-party associated with the advertisement.

15. The media of claim 11, wherein the software is further operable when executed by one or more computer systems to:
receive an input to the web-based application from the user via the interface of the web-based application presented to the user in the search container;
update the interface of the web-based application in response to the input; and
transmit the updated interface of the web-based application to the network device associated with the user for presentation to the user in the search container.
